(19) United States
(12) Patent Application Publication
(10) Pub. No.: US 2010/0326922 A1
(43) Pub. Date: Dec. 30, 2010

(54) OIL WATER SEPARATION APPARATUS

(75) Inventors: Kripa Kiran Varanasi, Cambridge, MA (US); Ambarish Jayant Kulkarni, Niskayuna, NY (US); Christopher Edward Wolfe, Niskayuna, NY (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/492,219

(22) Filed: Jun. 26, 2009

(51) Int. Cl. B01D 17/022; B01D 17/02; B01D 19/00; B01D 17/04

(52) U.S. Cl. 210/708; 210/513; 210/512.1; 210/435

(57) ABSTRACT

In one aspect, the present invention provides a subsea separation vessel for the separation of a mixture comprising oil and water comprising (a) at least one inlet for introducing a oil-water mixture; (b) a flow path for conducting the oil-water mixture; (c) at least one oil-water separation structure; and (d) at least one fluid outlet. The oil-water separation structure includes a multifunctional surface. The oil-water separation structure is located within the flow path and wherein the multifunctional surface is superhydrophobic with respect to water, and either oleophilic or superoleophilic with respect to oil. A method for separating oil from an oil-water mixture is also provided.

### BACKGROUND

The invention relates to a subsea oil-water separation vessel. In addition, the present disclosure relates to a method for separating oil from an oil-water mixture.

There are various industrial applications in which it is desirable to separate the oil and water phases of a fluid stream into discrete components. In the petroleum industry, crude oil recovered from wells penetrating subterranean oil-bearing formations is usually accompanied by water. Since the crude oil when it is sold to a pipeline or other transportation facility should be substantially free of water, e. g. have a water content of less than 1 or 2% by volume, it becomes necessary to provide for dehydration of the oil at the field processing facility associated with the production wells.

The complexity of oil-water separation facilities depends upon the form of the water found in association with the oil. Where the water present in the production stream is substantially “free water”, the oil and water are readily separated because of their different densities. In this case satisfactory separation usually can be accomplished simply by passing the production stream into a vessel in which gravity segregation occurs. However, in many cases the oil and water are mixed together in an emulsified condition which is highly stable. Typically, the emulsion is of a water-in-oil type in which water droplets are dispersed throughout the oil. The water droplets in an oil-field emulsion may vary widely in size, from very minute particles of only a few microns or less up to relatively large particles of several millimeters in diameter. Particularly in the case of water-in-oil emulsions in which the water phase is dispersed in very small droplet form, such emulsions can often times be broken only with difficulty.

There are, many known processes and apparatuses for the removal of oil from water. Typical of these are the centrifugal separators in which the oil and water are separately positioned by centrifugal force because of their varying densities and are then separated from each other by decantation. Other known processes include mechanical coalescers, those which absorb oil from water with a selective material such as a plastic foam or with a cellulose fiber mat.

An apparatus in which an oil-water mixture can be quickly and effectively separated into essentially pure oil and pure water outlet streams utilizing a multi-stage coalescer unit is known. The apparatus employs the concept of adding an oil-based solvent to an oil-water mixture recovered from the surface of a body of water in order to reduce the viscosity of the oil in the oil-water mixture to a level which permits the oil-water mixture to be effectively separated in an oil-water coalescer without causing the coalescer to become fouled or clogged. However, despite the fact that the method and apparatus have been found to be extremely effective for separating the oil in an oil-water mixture, it has been found that in some instances, particularly when dealing with oils having extremely high viscosity residual oil fractions, it can be impractical to add sufficient quantities of solvent to make it possible to process an oil-water mixture in an oil-water coalescer. In addition, in some instances it may be impractical to carry sufficient quantities of solvent on board a marine vessel operating on the surface of a body of water in order to process an oil-water mixture containing a high viscosity residual oil fraction in a continuous on-board operation wherein separated water is returned to the body of water.

In certain instances, large liquid retention tanks are required to stratify and separate oil and water. The process may be slow and at times not effective for the separations of an emulsion into its components. Typically, for separation of emulsions, chemical additives are employed. However, such additives have to be removed from the separated oil, leading to additional production costs. Generally, oil-water separations are conducted topside rather than below the surface, but in recent years subsea fluid processing has gained greater importance, especially in subsea operations in deep water. The large tanks required for gravity separation in deep water are disfavored due to their weight and logistical challenges associated with the installation and operation of a massive subsea structure.

Therefore, further improvements in separation vessels for subsea fluid processing are required. In particular further improvements are needed to provide compact and efficient separation vessels which may be used in subsea fluid processing. The present invention provides additional solutions to these and other challenges associated with oil-water separations.

### BRIEF DESCRIPTION

In one aspect, the present invention provides an oil-water subsea separation vessel comprising: (a) at least one inlet for introducing an oil-water mixture; (b) a flow path for conducting the oil-water mixture; (c) at least one oil-water separation structure having a multifunctional surface, the structure being located within the flow path; and (d) at least one fluid outlet; wherein the multifunctional surface is superhydrophobic with respect to water, and either oleophilic or superoleophilic with respect to oil.

In another aspect, the present invention provides a subsea separation vessel for the separation of a mixture comprising oil and water comprising: (a) at least one inlet for introducing a oil-water mixture; (b) a flow path for conducting the oil-water mixture; (c) at least one cyclonic separator comprising a multifunctional surface, the cyclonic separator being disposed within the flow path; and (d) a plurality of fluid outlets; wherein the multifunctional surface is superhydrophobic with respect to water, and either oleophilic or superoleophilic with respect to oil.

In yet another aspect, the present invention provides a method for separating oil from an oil-water mixture comprising: (a) introducing an oil-water mixture into an oil-water subsea separation vessel via an inlet; (b) conducting the oil-water mixture along a flow path comprises within the oil-water subsea separation vessel; (c) contacting the oil-water mixture with at least one oil-water separation structure having a multifunctional surface, the separation structure being located within the flow path, to provide an oil-rich fraction and a water-rich fraction, and wherein the multifunctional surface is superhydrophobic with respect to water, and either oleophilic or superoleophilic with respect to oil; and (d) separating the oil-rich fraction from the water-rich fraction.

These and other features, aspects, and advantages of the present invention may be understood more readily by reference to the following detailed description.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1 is a cross-sectional view of a subsea separation vessel, in accordance with one aspect of the invention.

FIG. 2 is a schematic representation of the multifunctional surface, in accordance with one aspect of the invention.

FIG. 3 is a cross-sectional of the oil-water separation structure, in accordance with one aspect of the invention.

FIG. 4 is a cross-sectional of the oil-water separation structure, in accordance with one aspect of the invention.

FIG. 5 is a cross-sectional view of a subsea separation vessel, in accordance with one aspect of the invention.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As noted, in one embodiment the present invention provides a subsea separation vessel for the separation of a mixture comprising oil and water comprising (a) at least one inlet for introducing a oil-water mixture; (b) a flow path for conducting the oil-water mixture; (c) at least one oil-water separation structure having a multifunctional surface and (d) at least one fluid outlet. The oil-water separation structure is located within the flow path for conducting the oil-water mixture.

As used herein, “oil” means crude oil from a geologic oil deposit. Crude oil is especially prone to the formation of highly stable emulsions due to its chemical complexity which varies from deposit to deposit, its occurrence in nature with water containing a variety of inorganic species, and the considerable shear forces that the contents of an oil deposit may experience during capture by a man-made conduit. Thus, the separation of such stable oil-water emulsions, at times herein referred to as oil-water mixtures, can present challenges unique to a specific field. It is believed that the present invention provides a generalized solution to such challenges.

In one embodiment, the oil-water mixture substantially includes water. In another embodiment, the oil-water mixture substantially includes oil. As used herein, “substantially” is defined as containing at least greater than 75 percent one of the constituent in the oil-water mixture.

As used herein, “multifunctional surface” is defined as a surface having specific susceptibility to interaction with water and oil. The specific susceptibility may be measured using contact angle. As used herein “contact angle” or “static contact angle” is the angle formed between a stationary drop of a reference liquid and a horizontal surface upon which the droplet is disposed, as measured at the liquid/substrate interface. Contact angle may be used as a measure of the wettability of the surface. If the liquid spreads completely on the surface and forms a film, the contact angle is 0 degrees. Contact angle may be used to identify the type of interaction between the surface with oil and water as shown in Table 1 below.

TABLE 1

| | | superphilic | philic | Phobic | superphobic |
|---|---|---|---|---|---|
| Water Contact | <0 | ✓ | — | — | — |
| Angle | 0-89 | — | ✓ | — | — |
| | 90-150 | — | — | ✓ | — |
| | >150 | — | — | — | ✓ |
| Oil Contact Angle | <0 | ✓ | — | — | — |
| | 0-89 | — | ✓ | — | — |
| | 90-150 | — | — | ✓ | — |
| | >150 | — | — | — | ✓ |

In one embodiment, the multifunctional surface is an oleophilic-hydrophobic surface characterized by a water contact angle of greater than 90 degrees and an oil contact angle of less than 90 degrees. In another embodiment, the multifunctional surface is an oleophilic-superhydrophobic surface characterized by a water contact angle of greater than 150 degrees and an oil contact angle of less than 90 degrees. In another embodiment, the multifunctional surface is an oleophobic-hydrophilic surface characterized by a water contact angle of less than 90 degrees and an oil contact angle of greater than 90 degrees. In yet another embodiment, the multifunctional surface is an oleophobic-hydrophilic surface characterized by a water contact angle of less than 90 degrees and an oil contact angle of greater than 150 degrees. In yet another embodiment, the multifunctional surface is an oleophobic-superhydrophobic surface characterized by a water contact angle of greater than 150 degrees and an oil contact angle of greater than 90 degrees. In an alternate embodiment, the multifunctional surface is a superoleophobic-hydrophobic surface characterized by a water contact angle of greater than 90 degrees and an oil contact angle of greater than 150 degrees.

In one embodiment, the multifunctional surface is superhydrophobic with respect to water, and either oleophilic or superoleophilic with respect to oil. In another embodiment, the multifunctional surface is superoleophobic with respect to oil, and either hyrdophilic or superhydrophilic with respect to water.

As used herein, the term “oleophobic surface” or “superoleophobic surface” means any surface that reduces the tendency for an oil to attach to that surface or form a film on that surface, including all superoleophobic surfaces. Oleophobic surfaces are characterized by reduced build-up and more facile removal of oils from the surface, compared to surfaces that are not oleophobic in nature. As used herein the term “hydrophobic surface” means any surface that reduces the tendency for water to attach to that surface or form a film on that surface.

In one embodiment, the multifunctional surface is a cyclone. In an alternate embodiment, the multifunctional surface is a multifunctional screen. In yet another embodiment, the multifunctional surface is a concentric tube.

In one embodiment, the multifunctional surface includes a multifunctional coating layer. In one embodiment, the multifunctional coating includes at least one metal nitride. Non-limiting examples of metal nitrides include transition metal nitrides such as chromium nitride, zirconium nitride, boron nitride, dichromium nitride, titanium aluminum nitride, chromium aluminum nitride, and titanium nitride, alkaline earth metal nitrides and alkali metal nitrides. In another embodiment, the multifunctional coating includes at least one metal oxide. In one embodiment, the metal oxide includes at least one of aluminum oxides, silicon oxides, and rare earth oxides. In another embodiment, the multifunctional coating includes at least one metal carbide. In one embodiment, the metal carbide includes at least one transition metal carbide; alkaline earth metal carbides such as calcium carbide; silicon carbide; calcium magnesium carbide. Examples of transition metal carbides include but are not limited to chromium carbide, boron carbide, tungsten carbide, and titanium carbide. In one embodiment, the multifunctional surface can include a boronized surface. In another embodiment, the multifunctional surface can include a nitrided surface

In one embodiment, the multifunctional surface includes at least one zero valent metal selected from the group consisting of electroless nickel, electroless nickel-poly(tetrafluoroethylene) composite, hard chrome, hard chrome-poly(tetrafluoroethylene) composites, and combinations thereof.

In another embodiment, the multifunctional surface includes at least one organic polymeric material. Non-limiting examples of polymeric materials includes polyvinyl chloride, polyolefins, polyesters, polyamides, polysulfones, polyimides, polyether sulfones, polyphenylene sulfides, polyether ketones, polyether ether ketones, ABS resins, polystyrenes, polybutadiene, polyacrylates, polyaklylacrylates, polyacrylonitrile, polyacetals, polycarbonates, polyphenylene ethers (e.g., blended with polystyrene or rubber-modified polystyrene), ethylene-vinyl acetate copolymers, polyvinyl acetate, liquid crystal polymers, ethylene-tetrafluoroethylene copolymers, aromatic polyesters, polyvinyl fluoride, polyvinylidene fluoride, polyvinylidene chloride, tetrafluoroethylene, polyimide, polyetherimide, cyano modified polyetherimide, polyvinylidine fluoride-trifluoroethylene P(VDF-TrFE), polyvinylidene-tetrafluoroethylene copolymers P(VDF-TFE), polyvinylidine trifluoroethylene hexafluoropropylene copolymers P(VDF-TFE-HFE), polyvinylidine hexafluoropropylene copolymers P(VDF-HFE) and poly(vinylidine fluoride-trifluoroethylene-chlorofluoroethylene) terpolymer, cyanoethyl pullulan, cyanoethyl polyvinylalcohol, cyanoethyl hydroxyethyl cellulose, cyanoethyl sucrose, cyanoethyl-containing organopolysiloxane, or cyanoethyl cellulose. Physical blends of various polymers can also be used. Moreover, various copolymers, such as star block copolymers, graft copolymers, alternating block copolymers or random copolymers, ionomers, dendrimers, and reaction products of the various polymers, may also be used. In one embodiment, the polymeric material is selected from the group consisting of fluoropolymers and silicone polymers. In another embodiment, the organic polymeric material is poly(tetrafluoroethylene). In one embodiment, the multifunctional surface comprises superhydrophobic poly(ethylene).

In one embodiment, the subsea oil-water separation vessel includes a gas-liquid separator. The subsea oil-water separation vessel can provide an oil-rich fraction and a water-rich fraction.

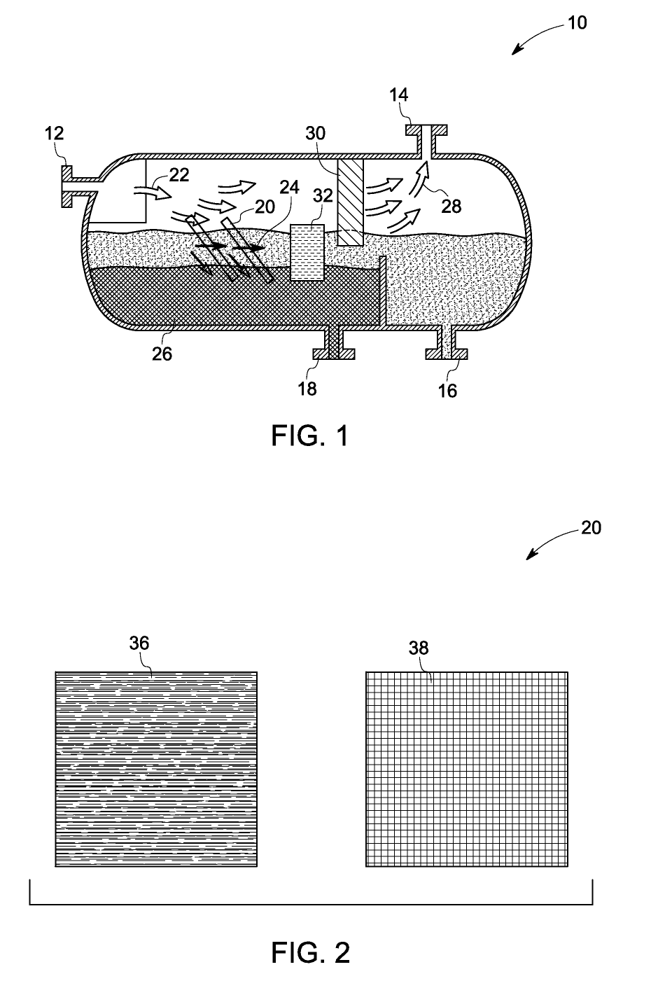

FIG. 1 depicts a subsea separation vessel (10) in one embodiment of the present invention. The subsea separation vessel has an inlet (12) for introducing a mixture of oil and water (22). The oil and water mixture is then contacted with at least one oil-water separation structure having multifunctional surface (20). In the embodiment shown in FIG. 1, the oil-water separation structure (20) comprises a multifunctional surface which is superhydrophobic and oleophilic as for example when the separation structure is a screen made of superhydrophobic poly(ethylene) (See Examples Section for details). Because the separation structure is superhydrophobic, the oil-water mixture tends to become enriched in oil (24) which passes through the separation structure and depleted in water as the oil-water mixture encounters the separation structure. Water droplets within the oil-water mixture may coalesce and are directed downward toward water layer (26). In the embodiment shown, the oil is further contacted with an advanced coalescer (32) and is collected near an oil outlet (16). The water (26) is collected near a water outlet (18). A mist extractor (30) is placed in the flow path of the oil-water mixture and any gaseous component (28) that may be present in the mixture or that may be evolved during the flow of the oil-water mixture exits the separator vessel through a gas outlet (14). The oil (24) may be pumped to the surface for utilization or if need be recycled to the same subsea separator for additional enrichment. Alternatively, the oil (24) may be further transferred to one or more additional subsea separation units prior to its being pumped to the surface. The water (26) may be pumped back into the oil reservoir (not shown) or if need be recycled to the same subsea separator for additional separation. Alternatively, the water (26) may be further transferred to one or more additional subsea separation units prior to its being pumped back into the oil reservoir. The gases components (28) may be directed back to the reservoir or to a surface capture unit (not shown).

As shown in FIG. 2 in one embodiment, the oil-water separation structure having a multifunctional surface (20) can be a porous medium having holes or inter connected pores (36). In another embodiment, the oil-water separation structure having a multifunctional surface (20) can be a wire mesh structure (38). The porous structures are optimized to accommodate the high flow rates anticipated for the oil-water mixtures through the subsea separator.

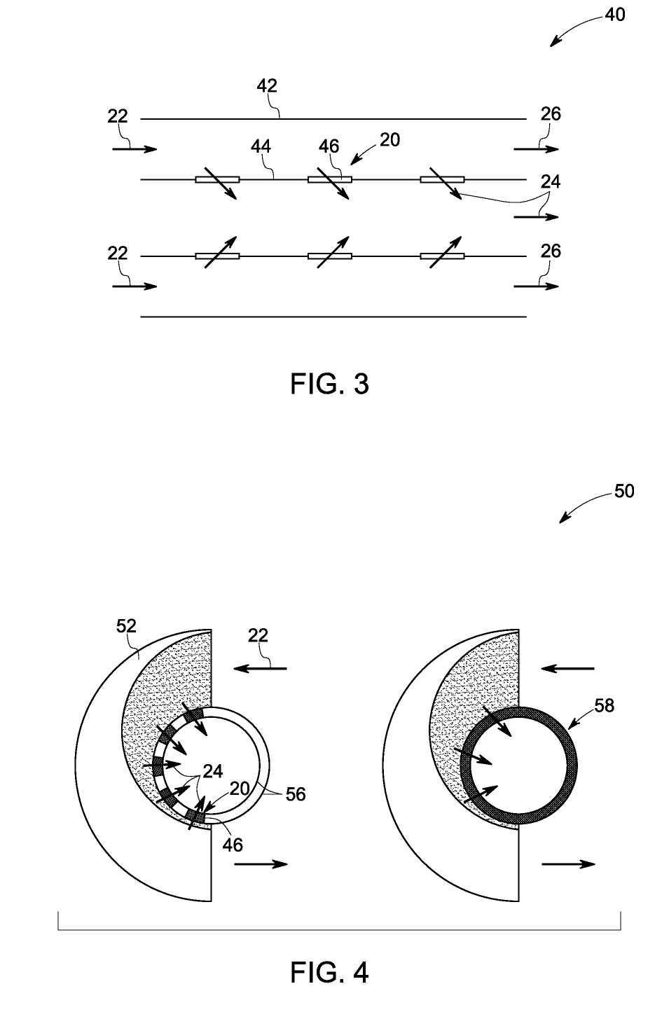

The oil-separation structure can be placed in a manner known to one skilled in the art such that the oil-water mixture flows through the separation structure. In one embodiment, as shown in FIG. 3, the separation structure (40) includes a collinear/coaxial tube having an outer tube (42) and an inner tube (44). The inner tube includes filter plates (46) with multifunctional surface (20) (oleophilic and hydrophobic). In one embodiment, the filter plates are located at regular intervals along the inner tube. In another embodiment, the filter plates may be placed in a continuous manner along the inner tube. The oil-water mixture (22) is contacted with the separation structure, the oil (24) from the oil-water mixture is allowed to pass through the multifunctional surface into the inner tube. The oil from the inner tube (24) is then collected. The water from the oil-water mixture flows through the outer tube without being able to enter the inner tube due to the hydrophobic nature of the multifunctional surface filter plates on the inner tube. The water from the outer tube (26) is collected. In one embodiment, a centrifugal action is used for separation.

In one embodiment, as shown in FIG. 4, the separation structure (50) includes a multifunctional surface (20) that is a concentric tube (52) having an outer tube (54) and an inner tube (56). The inner tube includes filter plates (46) with multifunctional surface (20) (oleophilic and hydrophobic). In one embodiment, the filter plates are located at regular intervals along the inner tube. In another embodiment, the filter plates may be placed in a continuous manner (58) along the inner tube. The oil-water mixture (22) is contacted with the separation structure, the oil (24) from the oil-water mixture is allowed to pass through the multifunctional surface into the inner tube. The oil from the inner tube (24) is then collected. The water (26) from the oil-water mixture flows through the outer tube without being able to enter the inner tube due to the hydrophobic nature of the multifunctional surface filter plates on the inner tube. The water from the outer tube (26) is collected. In one embodiment, a centrifugal action is used for separation.

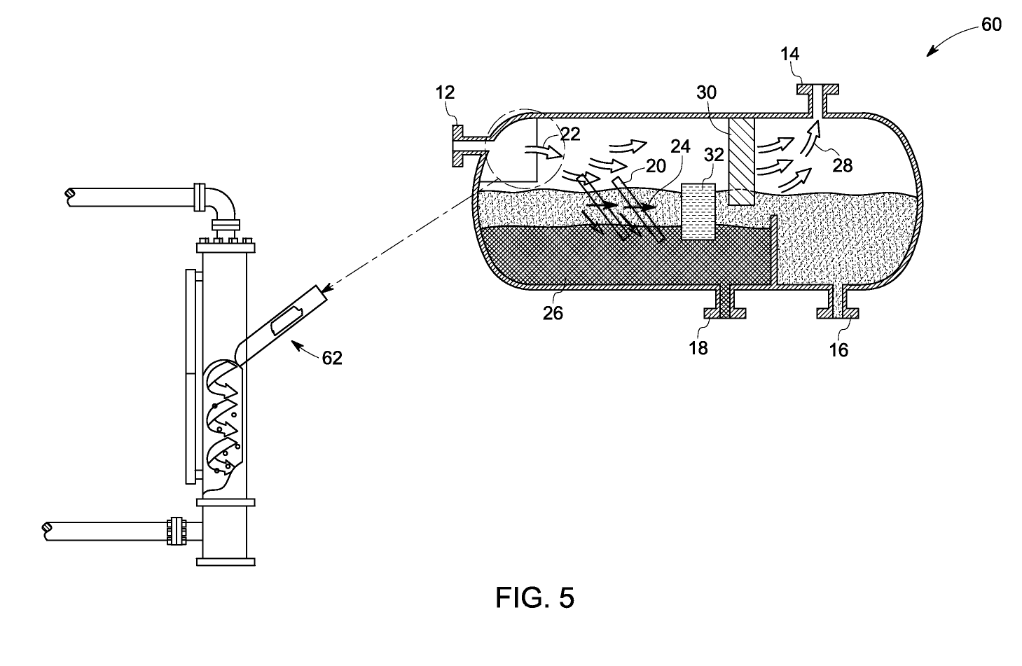

FIG. 5 depicts a subsea separation vessel (60) comprising a cyclonic separator (62) having a multifunctional surface configured for contact with an oil-water-gas mixture. In the embodiment featured in FIG. 5 the inner surface of the cyclonic separator is multifunctional in the sense that it is superhydrophobic with respect to water and oleophilic with respect to oil.

### EXAMPLES

The following examples illustrate methods and embodiments in accordance with the invention. Known techniques for preparing superhydrophobic polyethylene and superhydrophobic poly(tetrafluoroethylene) may be found in Science and Technology of Advanced Materials 9, (2008) 045007 and Journal of Materials Chemistry 2006, 16, 1741-1745, respectively, are relied upon herein, and are incorporated by reference herein.

### Example 1

A 1 meter by 1 meter stainless steel mesh screen having an average pore size of about 1 cm by 1 cm and a mesh thickness of about 0.25 cm is treated with a hot solution of linear low density poly(ethylene) (LLDPE) in xylene-ethanol in an amount sufficient to coat the mesh surfaces while leaving the pores open. The coating of LLDPE on the stainless steel is superhydrophobic and oleophilic. A plurality of such treated mesh screens is then disposed within the flow path of a subsea separation vessel.

### Example 2

A cyclic separator comprising an interior surface made of LLDPE is attached to a source of hot (120° C.) xylene. Hot xylene is passed through the cyclonic separator over a period of time ranging from about 1 minute to about 10 minutes. The feed of hot toluene is discontinued and immediately thereafter a hot mixture of xylene and ethanol (1:1) is recirculated through the cyclonic separator. Heating of the recirculating mixture of xylene and ethanol is discontinued and recirculation is continued until the temperature of the xylene-ethanol mixture reaches ambient temperature. The treated interior surface of the cyclonic separator is superhydrophobic and oleophilic.

### Example 3

The inner tube of a concentric tube separator constructed of LLDPE is immersed in hot xylene for a period ranging from about 1 minute to about 10 minutes. A volume of ethanol equal to the volume of xylene is then added and the bath is allowed to cool to ambient temperature. The inner tube of the concentric separator is then disposed within the outer tube of the concentric separator and the concentric separator is disposed within the flow path of a subsea separation vessel. The surfaces of the treated inner tube of the concentric tube separator is superhydrophobic and at least oleophilic.

The foregoing examples are merely illustrative, serving to exemplify only some of the features of the invention. The appended claims are intended to claim the invention as broadly as it has been conceived and the examples herein presented are illustrative of selected embodiments from a manifold of all possible embodiments. Accordingly, it is the Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. An oil-water subsea separation vessel comprising:
(a) at least one inlet for introducing an oil-water mixture;
(b) a flow path for conducting the oil-water mixture;
(c) at least one oil-water separation structure having a multifunctional surface, the structure being located within the flow path; and
(d) at least one fluid outlet;
wherein the multifunctional surface is superhydrophobic with respect to water, and either oleophilic or superoleophilic with respect to oil.

2. The subsea separation vessel according to claim 1, wherein the separation structure having a multifunctional surface is a cyclonic separator.

3. The subsea separation vessel according to claim 1, wherein the separation structure having a multifunctional surface is a screen.

4. The subsea separation vessel according to claim 1, wherein the separation structure having a multifunctional surface is a concentric tube separator.

5. The subsea separation vessel according to claim 1, wherein the multifunctional surface comprises a coating layer

6. The subsea separation vessel according to claim 1, wherein the multifunctional surface comprises at least one metal nitride.

7. The subsea separation vessel according to claim 1, wherein the multifunctional surface comprises at least one metal oxide.

8. The subsea separation vessel according to claim 1, wherein the multifunctional surface comprises at least one metal carbide.

9. The subsea separation vessel according to claim 1, wherein the multifunctional surface comprises at least one zero valent metal.

10. The subsea separation vessel according to claim 1, wherein the multifunctional surface comprises at least one organic polymeric material.

11. The subsea separation vessel according to claim 1, wherein the multifunctional surface comprises superhydrophobic poly(tetrafluoroethylene).

12. The subsea separation vessel according to claim 1, wherein the multifunctional surface comprises superhydrophobic poly(ethylene).

13. The subsea separation vessel according to claim 1, wherein the multifunctional surface comprises a nitrided surface.

14. The subsea separation vessel according to claim 1, further comprising an advanced coalescer.

15. A subsea separation vessel for the separation of a mixture comprising oil and water comprising:
(a) at least one inlet for introducing a oil-water mixture;
(b) a flow path for conducting the oil-water mixture;
(c) at least one cyclonic separator comprising a multifunctional surface, the cyclonic separator being disposed within the flow path; and
(d) a plurality of fluid outlets;
wherein the multifunctional surface is superhydrophobic with respect to water, and either oleophilic or superoleophilic with respect to oil.

16. A method for separating oil from an oil-water mixture comprising:
(a) introducing an oil-water mixture into an oil-water subsea separation vessel via an inlet;
(b) conducting the oil-water mixture along a flow path comprises within the oil-water subsea separation vessel;
(c) contacting the oil-water mixture with at least one oil-water separation structure having a multifunctional surface, the separation structure being located within the flow path, to provide an oil-rich fraction and a water-rich fraction, and wherein the multifunctional surface is superhydrophobic with respect to water, and either oleophilic or superoleophilic with respect to oil; and
(d) separating the oil-rich fraction from the water-rich fraction.

17. The method of claim 16, wherein the oil-water subsea separation vessel further comprises a gas-liquid separator.

18. The method according to claim 17, wherein the gas liquid separator is a cyclonic separator comprising a multifunctional surface.

19. The method according to claim 16, wherein said oil-water separation structure having a multifunctional surface is a concentric tube separator which is superhydrophobic with respect to water and oleophilic or superoleophilic with respect to oil.

20. The method according to claim 16, wherein said oil-water separation structure is a screen separator having a multifunctional surface which is superhydrophobic with respect to water and oleophilic or superoleophilic with respect to oil.
